(19) United States
(12) Patent Application Publication
(10) Pub. No.: US 2015/0183336 A1
(43) Pub. Date: Jul. 2, 2015

(54) STARTUP LIMITATION APPARATUS AND METHOD FOR FUEL CELL VEHICLE

(71) Applicants: Hyundai Motor Company, Seoul (KR); Kia Motors Corporation, Seoul (KR)

(72) Inventors: Min Kyung Kim, Incheon (KR); Sang Hyun Kim, Seongnam (KR); Ji Hyun Shim, Seoul (KR)

(21) Appl. No.: 14/541,937

(22) Filed: Nov. 14, 2014

(30) Foreign Application Priority Data
Dec. 31, 2013 (KR) 10-2013-0168518

(51) Int. Cl. B60L 11/18

(52) U.S. Cl. CPC B60L 11/1885; B60L 11/1888

(57) ABSTRACT

A startup limitation method for a fuel cell vehicle. In particular, a sensor is used to determine whether or not a hydrogen inlet door of the fuel cell vehicle is opened. When the hydrogen inlet door is opened, shutting down the fuel cell vehicle. A pressure of a hydrogen storage tank of the fuel cell vehicle is measured, and in response, the fuel cell vehicle is shut down when an increase of the pressure of the hydrogen storage tank of the fuel cell vehicle exceeds a predetermined pressure variation range if the fuel cell vehicle has not already been shut down due to the hydrogen inlet door of the fuel cell vehicle being opened.

### CROSS-REFERENCE TO RELATED APPLICATION

This application claims under 35 U.S.C. §119(a) the benefit of Korean Patent Application No. 10-2013-0168518 filed on Dec. 31, 2013, the entire contents of which are incorporated herein by reference.

### BACKGROUND

(a) Technical Field

The present disclosure relates to a startup limitation apparatus and method for a fuel cell vehicle. More particularly, the present disclosure relates to a startup limitation apparatus and method for a fuel cell vehicle, which limits a startup by sensing whether or not hydrogen fuel is injected into a vehicle even when a defect occurs in a sensor for sensing the opening of a hydrogen fuel inlet door of the fuel cell vehicle.

(b) Background Art

Generally, fuel cell vehicles use hydrogen as fuel. Hydrogen has a high energy density per unit mass and a high calorific value per unit mass but has a very small density compared to other carbon hydrocarbon fuels, and thus the energy density per unit volume is very small.

Accordingly, in order to maximize the hydrogen utilization efficiency, hydrogen fuel is compressed and stored in a high-pressure hydrogen storage tank of about 700 bars. However, hydrogen gas has the largest thermal conductivity, among gases, a fast diffusion, and a low ignition energy, and thus the ignition of the hydrogen in the tank can easily occur. Accordingly, when hydrogen is stored, attention to the storage efficiency and the safety is needed.

Particularly, when a vehicle starts up or operates during the charging of hydrogen, hydrogen is discharged. In this case, an explosion could occur due to the high ignitability of hydrogen. In order to prevent this danger, Europe Vehicle Regulation (406/2010/EC) provides that a fuel cell vehicle must be prevented from starting up during the charging of hydrogen, and also provides that a fuel cell vehicle must be configured to automatically turn off or charging is stopped when charging is attempted while the vehicle is running or attempted to be started.

For example, one way to detect when the vehicle is being recharged with hydrogen is to provide a sensor that is attached to a fuel inlet door to monitor whether or not charging is being performed. However, when only a sensor provided on the fuel inlet door is used and the door sensor fails, the charging state cannot be identified, and thus the startup of a fuel cell vehicle cannot be prevented effectively.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure provides a startup limitation apparatus and method for a fuel cell vehicle, which can limit a startup by recognizing a charging state using a pressure sensor and a temperature sensor in addition to a door sensor provided on a hydrogen fuel inlet door even in a situation when the door sensor has failed.

In one aspect, the present disclosure provides a startup limitation method for a fuel cell vehicle, comprising: sensing whether or not a hydrogen inlet door of the fuel cell vehicle is opened; shutting down the fuel cell vehicle when the hydrogen inlet door is opened; measuring a pressure of a hydrogen storage tank of the fuel cell vehicle; and in response to measuring an increase in pressure that exceeds a predetermined pressure variation range in the hydrogen storage tank of the fuel cell vehicle, shutting down the fuel cell vehicle if the vehicle has not already been shut down due to the hydrogen inlet door of the fuel cell vehicle being opened.

In an exemplary embodiment, after the shutting down of the fuel cell vehicle when the increase of the pressure of the hydrogen storage tank of the fuel cell vehicle exceeds the predetermined pressure variation range, the method may further include: measuring a temperature of the hydrogen storage tank of the fuel cell vehicle; and in response to measuring an increase in temperature that exceeds a predetermined temperature variation range in the hydrogen storage tank of the fuel cell vehicle temperature, shutting down the fuel cell vehicle if the vehicle has not already been shut down due to the hydrogen inlet door of the fuel cell vehicle being opened or the pressure exceeding the predetermined temperature variation.

In another aspect, the present disclosure provides a startup limitation method for a fuel cell vehicle, comprising: sensing whether or not a hydrogen inlet door of the fuel cell vehicle is opened; shutting down the fuel cell vehicle when the hydrogen inlet door is opened; measuring a temperature of a hydrogen storage tank of the fuel cell vehicle; and shutting down the fuel cell vehicle when an increase of the temperature of the hydrogen storage tank of the fuel cell vehicle exceeds a predetermined temperature variation range and the fuel cell vehicle has not already been shut down due to the hydrogen inlet door being opened.

In an exemplary embodiment, after the shutting down of the fuel cell vehicle when the increase of the temperature of the hydrogen storage tank of the fuel cell vehicle exceeds the predetermined temperature variation range, the method may further include: measuring a pressure of the hydrogen storage tank of the fuel cell vehicle; and shutting down the fuel cell vehicle when an increase of the pressure of the hydrogen storage tank of the fuel cell vehicle exceeds a predetermined pressure variation range and the fuel cell vehicle has not already been shut down due to the hydrogen inlet door being opened.

In another exemplary embodiment, the shutting down of the fuel cell vehicle when the hydrogen inlet door is opened may include displaying on an instrument panel of the fuel cell vehicle that the hydrogen inlet door is opened prior to shutting down the fuel cell vehicle.

In still another exemplary embodiment, the shutting down of the fuel cell vehicle when the increase of the pressure of the hydrogen storage tank of the fuel cell vehicle exceeds a predetermined pressure variation range may include displaying on an instrument panel of the fuel cell vehicle that the hydrogen inlet door is opened prior to shutting down the fuel cell vehicle.

In still another aspect, the present disclosure provides a startup limitation apparatus for a fuel cell vehicle, comprising: a door open sensor configured to sense whether or not a hydrogen inlet door of the fuel cell vehicle is opened; a pressure measuring unit configured to measure a pressure of a hydrogen storage tank of the fuel cell vehicle; a temperature measuring unit configured to measure a temperature variation of the hydrogen storage tank of the fuel cell vehicle; and a controller configured to receive a door open sensing signal from the door open sensor, a pressure value from the pressure measuring unit, and a temperature value from the temperature measuring unit to determine whether or not to shut down the fuel cell vehicle.

In an exemplary embodiment, the controller may allow the fuel cell vehicle to shut down when the controller receives a door open sensing signal indicating that the hydrogen inlet door is opened from the door open sensor, or when an increase of the pressure value from the pressure measuring unit exceeds a predetermined pressure variation range even though there is no input of the door open sensing signal from the door open sensor, or when an increase of the temperature value from the temperature measuring unit exceeds a predetermined temperature variation range even though there is no input of the door open sensing signal from the door open sensor. Other aspects and exemplary embodiments of the invention are discussed infra.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure, and wherein:

FIG. 1 is a view illustrating a startup of a fuel cell vehicle when only a door sensor is provided on the fuel cell vehicle and the door sensor is defective;

FIG. 2 is a view illustrating a concept of a startup limitation method for a fuel cell vehicle according to an exemplary embodiment of the present disclosure;

FIG. 3 is a flowchart illustrating a startup limitation method for a fuel cell vehicle according to an exemplary embodiment of the present disclosure;

FIG. 4 is a view illustrating a state of a fuel cell vehicle through an instrument panel in a startup limitation method for the fuel cell vehicle according to an exemplary embodiment of the present disclosure; and

FIG. 5 is a view illustrating another state of a fuel cell vehicle through an instrument panel in a startup limitation method for the fuel cell vehicle according to an exemplary embodiment of the present disclosure.

It should be understood that the accompanying drawings are not necessarily to scale, presenting a somewhat simplified representation of various exemplary features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter reference will now be made in detail to various embodiments of the present disclosure, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

Hereinafter, exemplary embodiments of the present disclosure will be described in detail with reference to the accompanying drawings so that those skilled in the art can easily carry out the present disclosure.

Since the present disclosure can be modified into various types, exemplary embodiments will be illustrated in the drawings and described in this disclosure in detail. However, the present disclosure is not limited to a specific disclosure type, but should be construed as including all modifications, equivalents, substitutes involved in the scope and the technological range of the present disclosure.

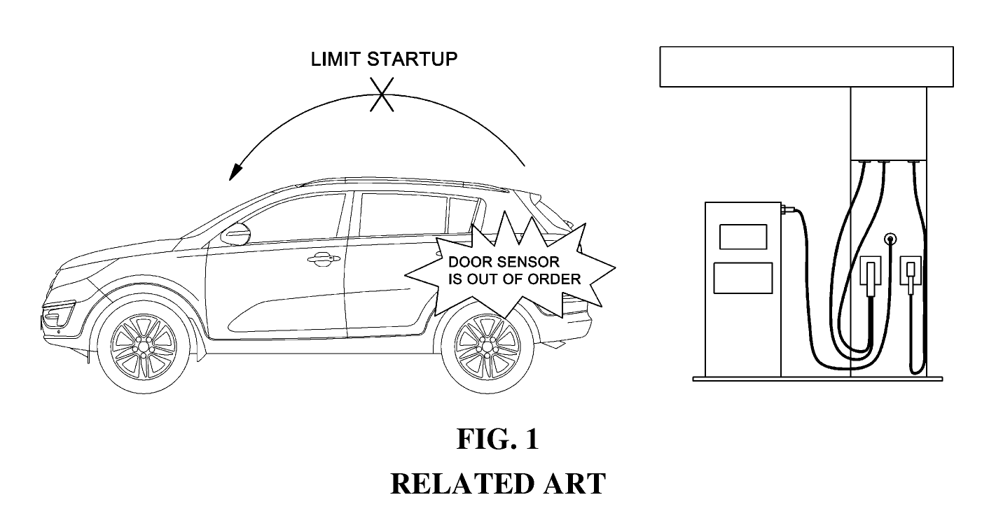

FIG. 1 is a view illustrating a startup of a fuel cell vehicle when only a door sensor is provided on the fuel cell vehicle and the door sensor is defective. The door sensor of the fuel cell vehicle may sense using a hall sensor or a contact sensor that the vehicle is being charged when a fuel door is opened. In principle, when the hydrogen inlet door of the fuel cell vehicle is opened, the vehicle is prevented from starting up.

However, when the door sensor mounted on the hydrogen inlet door is out of order due to, for example, an external shock, the fuel cell vehicle may not sense that the hydrogen inlet door is actually opened. In this situation, when the fuel cell vehicle starts up, and a significant explosion could occur.

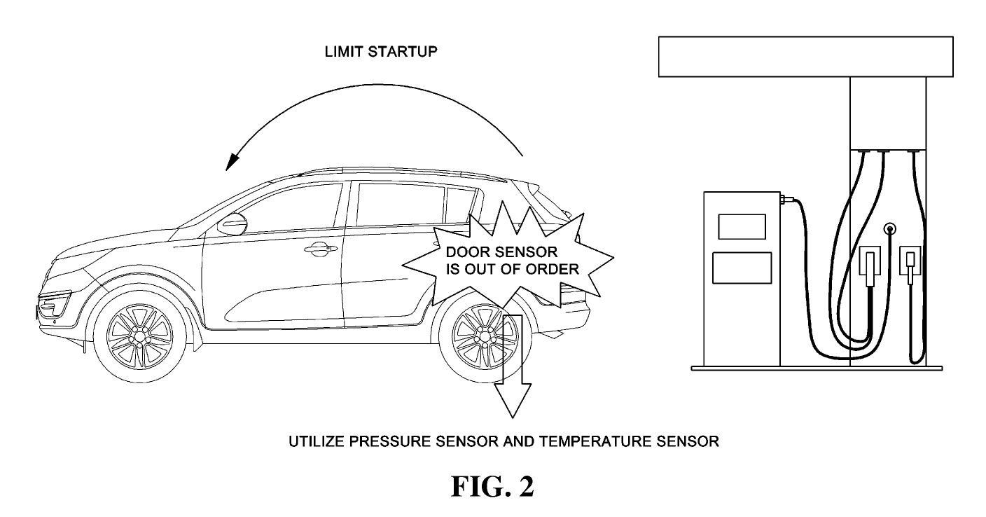

FIG. 2 is a view illustrating a concept of a startup limitation method for a fuel cell vehicle according to an exemplary embodiment of the present disclosure. The startup limitation method for the fuel cell vehicle according to the exemplary embodiment of the present disclosure may utilize a temperature sensor and a pressure sensor in addition to the door sensor attached to the hydrogen inlet door.

As such, even if the door sensor malfunctions due to an external shock, when the pressure and the temperature of a hydrogen storage tank rapidly increases, it may be determined that hydrogen is being injected into the hydrogen storage tank of a current vehicle, thus requiring limiting or preventative startup of the vehicle.

For example, in the startup limitation method for the fuel cell vehicle according to the exemplary embodiment of the present disclosure, even though the door sensor malfunctions, when the internal pressure of the hydrogen storage tank exceeds a predetermined pressure range for a predetermined time, a controller may be determined that hydrogen is being charged. The predetermined pressure or the predetermined time may be appropriately selected so as to show that hydrogen is being charged into a vehicle based on known pressure increase rates for hydrogen fill stations. For example, the pressure may be about 20 bars, and the time may be about 2 seconds (i.e., 10 bars/sec over the course of at least 2 seconds) thus indicating that the vehicle is being charged with hydrogen.

In addition, the startup limitation method for the fuel cell vehicle may further utilize a temperature sensor that can measure the internal temperature of the hydrogen storage tank. As such, even when the pressure sensor and the door sensor are both out of order, the fuel cell vehicle may be prevented from staring up.

For example, when the temperature increase for a predetermined time exceeds a predetermined temperature variation, it may be determined based thereon that a fuel cell vehicle is being charged with hydrogen. The values of the predetermined time and the predetermined temperature rising may be appropriately selected so as to sense that hydrogen is being charged. For example, when the internal temperature of the hydrogen storage tank rises about 30° C. or more for about 2 seconds (i.e., 15° C./sec over the course of at least 2 seconds), it may be determined that hydrogen is being charged.

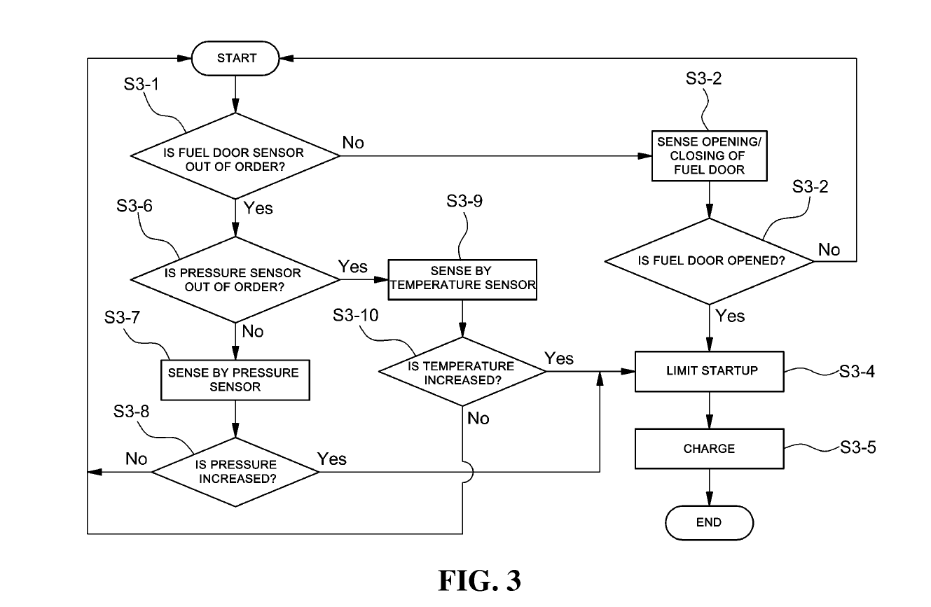

FIG. 3 is a flowchart illustrating a startup limitation method for a fuel cell vehicle according to an exemplary embodiment of the present disclosure. A startup limitation method for a fuel cell vehicle according to an exemplary embodiment of the present disclosure may include a process of checking whether or not a sensor of a fuel door is out of order (S3-1). In this process, when the fuel door sensor normally operates, a process of sensing opening or closing of a hydrogen inlet door may be performed (S3-2). When the hydrogen inlet door is opened (S3-3), the startup limitation method for the fuel cell vehicle may perform a process of limiting the startup of the fuel cell vehicle (i.e., preventing the vehicle from being started or shutting the vehicle down if it still running)(S3-4).

After the startup of the fuel cell vehicle is limited, the startup limitation method for the fuel cell vehicle may allow hydrogen to be injected through the hydrogen inlet (S3-5). However, when the fuel door sensor malfunctions, the startup limitation method for the fuel cell vehicle may undergo a process of checking whether or not a pressure sensor for measuring the pressure of the hydrogen storage tank of the fuel cell vehicle is out of order (S3-6).

When the pressure sensor normally operates, the startup limitation method for the fuel cell vehicle may perform a process of sensing whether or not the pressure of the hydrogen storage tank of the fuel cell vehicle is increasing using the pressure sensor (S3-8). In this process, when the internal pressure of the hydrogen storage tank of the fuel cell vehicle, this means that hydrogen is being injected. Accordingly, the startup limitation method for the fuel cell vehicle may perform a process of limiting the startup of the fuel cell vehicle (S3-4).

When the door sensor of the hydrogen inlet of the fuel cell vehicle malfunctions and the pressure sensor also malfunctions, the startup limitation method for the fuel cell vehicle may perform a process of measuring the temperature of the hydrogen storage tank of the fuel cell vehicle using the temperature sensor (S3-9). In this process, when a temperature variation measured by the temperature sensor rapidly increases (i.e., more than 30° C. over the course of at least 2 seconds), the startup limitation method for the fuel cell vehicle may perform the process of limiting the startup of the fuel cell vehicle (S3-4).

Thus, in the startup limitation method for the fuel cell vehicle according to the exemplary embodiment of the present disclosure, since it is possible to check whether or not hydrogen is being injected into a vehicle using the pressure sensor and/or the temperature sensor in addition to the sensor that senses the opening/closing of the fuel door to limit the startup of a vehicle, it is possible to prevent an accidental startup of a vehicle during the charging of hydrogen even when the door sensor is out of order due to the repeated opening/closing of the fuel door.

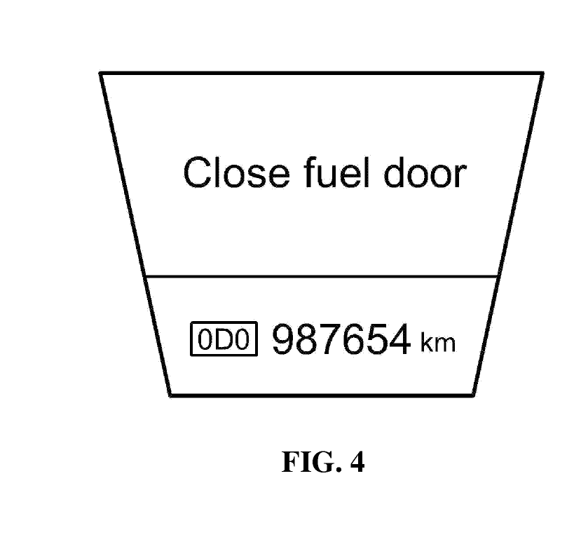

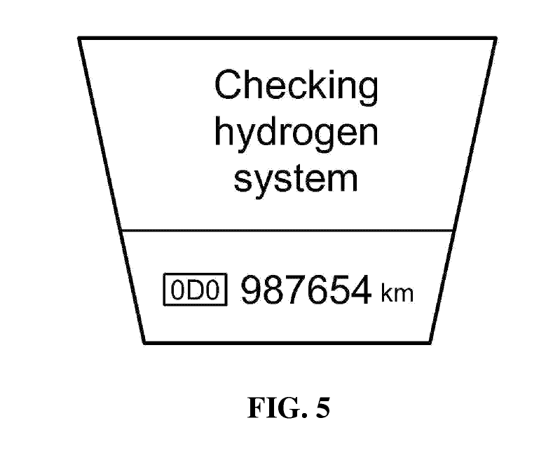

FIGS. 4 and 5 are views illustrating states of a fuel cell vehicle through an instrument panel in a startup limitation method for the fuel cell vehicle according to an exemplary embodiment of the present disclosure.

In FIG. 4, the startup limitation method for the fuel cell vehicle may display an expression “close fuel door” on the instrument panel to inform a driver that the door of the hydrogen inlet of the fuel cell vehicle is opened. In this state, when the speed of the vehicle is less than about 2 km/h, the startup limitation method for the fuel cell vehicle may shut down the fuel cell vehicle.

In FIG. 5, when the pressure of the hydrogen storage tank rapidly increases, the startup limitation method for the fuel cell vehicle may display a warning message “checking hydrogen system” on the instrument panel. In other words, this means that the pressure of the hydrogen storage tank of the fuel cell vehicle is sensed to increase even though the door is not opened. This may show that the door sensor malfunctions. Accordingly, the startup limitation method for the fuel cell vehicle may inform a driver of a warning message, and may perform a process of limiting the startup of a vehicle.

As described above, a startup limitation method for a fuel cell vehicle according to an embodiment of the present disclosure can limit a startup of the fuel cell vehicle by sensing charging of hydrogen using other sensors even when a door sensor of the fuel cell vehicle does not operates. Accordingly, the safety of a fuel cell vehicle can be significantly improved.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A startup limitation method for a fuel cell vehicle, comprising:
sensing whether or not a hydrogen inlet door of the fuel cell vehicle is opened;
shutting down the fuel cell vehicle when the hydrogen inlet door is opened;
measuring a pressure of a hydrogen storage tank of the fuel cell vehicle; and
shutting down the fuel cell vehicle when an increase of the pressure of the hydrogen storage tank of the fuel cell vehicle exceeds a pressure variation range if the fuel cell vehicle has not already been shut down due to the hydrogen inlet door of the fuel cell vehicle being opened.

2. The startup limitation method of claim 1, further comprising:
measuring a temperature of the hydrogen storage tank of the fuel cell vehicle; and
shutting down the fuel cell vehicle when an increase of the temperature of the hydrogen storage tank of the fuel cell vehicle exceeds a temperature variation range if the vehicle has not already been shut down due to the hydrogen inlet door of the fuel cell vehicle being opened or the increase of the pressure of the hydrogen storage tank of the fuel cell vehicle exceeding a pressure variation range.

3. A startup limitation method for a fuel cell vehicle, comprising:
sensing whether or not a hydrogen inlet door of the fuel cell vehicle is opened;
shutting down the fuel cell vehicle when the hydrogen inlet door is opened;
measuring a temperature of a hydrogen storage tank of the fuel cell vehicle; and
shutting down the fuel cell vehicle when an increase of the temperature of the hydrogen storage tank of the fuel cell vehicle exceeds a predetermined temperature variation range if the fuel cell vehicle has not already been shut down due to the hydrogen inlet door of the fuel cell vehicle being opened.

4. The startup limitation method of claim 3, further comprising:
measuring a pressure of the hydrogen storage tank of the fuel cell vehicle; and
shutting down the fuel cell vehicle when an increase of the pressure of the hydrogen storage tank of the fuel cell vehicle exceeds a predetermined pressure variation range if the fuel cell vehicle has not already been shut down due to the hydrogen inlet door of the fuel cell vehicle being opened or the increase of the pressure of the hydrogen storage tank of the fuel cell vehicle exceeding a temperature variation range.

5. The startup limitation method of claim 1, wherein the shutting down of the fuel cell vehicle when the hydrogen inlet door is opened comprises displaying on an instrument panel of the fuel cell vehicle that the hydrogen inlet door is opened and shutting down the fuel cell vehicle.

6. The startup limitation method of claim 1, wherein the shutting down of the fuel cell vehicle when the increase of the pressure of the hydrogen storage tank of the fuel cell vehicle exceeds a predetermined pressure variation range comprises displaying on an instrument panel of the fuel cell vehicle that the hydrogen inlet door is opened and shutting down the fuel cell vehicle.

7. A startup limitation apparatus for a fuel cell vehicle, comprising:
a door open sensor configured to sense whether or not a hydrogen inlet door of the fuel cell vehicle is opened;
a pressure measuring unit configured to measure a pressure of a hydrogen storage tank of the fuel cell vehicle;
a temperature measuring unit configured to measure a temperature variation of the hydrogen storage tank of the fuel cell vehicle; and
a controller configured to receive a door open sensing signal from the door open sensor, a pressure value from the pressure measuring unit, and a temperature value from the temperature measuring unit to determine whether or not to shut down the fuel cell vehicle.

8. The startup limitation apparatus of claim 7, wherein the controller allows the fuel cell vehicle to shut down when the controller receives a door open sensing signal indicating that the hydrogen inlet door is opened from the door open sensor, or when an increase of the pressure value from the pressure measuring unit exceeds a predetermined pressure variation range even though there is no input of the door open sensing signal from the door open sensor, or when an increase of the temperature value from the temperature measuring unit exceeds a predetermined temperature variation range even though there is no input of the door open sensing signal from the door open sensor.
